(19) United States
(12) Patent Application Publication
(10) Pub. No.: US 2020/0029726 A1
(43) Pub. Date: Jan. 30, 2020

(54) INJECTOR NEEDLE

(71) Applicant: CAFÉ TRÊS CORAÇÕES S/A, Sao Benedito (BR)

(72) Inventor: Cédric Pascal Santana Rocha-Siegenthaler, St. Gallen (CH)

(21) Appl. No.: 16/449,812

(22) Filed: Jun. 24, 2019

(30) Foreign Application Priority Data
Jul. 26, 2018 (BR) BR 20 2018 013929

(51) Int. Cl. A47J 31/40; A47J 31/46

(52) U.S. Cl. CPC A47J 31/407; A47J 31/46

(57) ABSTRACT

The present utility model refers to a constructive arrangement applied to an injector needle. More precisely, the present utility model refers to a constructive arrangement applied to an injector needle used in machines for preparing drinks from capsules. The injector needle (1) comprises a first end (2) endowed with a fastening means (3); a second end (4) endowed with a tip (5); a central portion (6) interconnecting the first and second ends (2, 4); wherein the first end (2) comprises an inlet orifice (7) and the second end (4) comprises an outlet orifice (8). The injector needle (1) further comprises a first inner channel (9) extending in parallel to a longitudinal axis (10) of the injector needle (1), the first inner channel (9) extending from the inlet orifice (7) and fluidly connecting to a second inner channel (11); the second inner channel (11) having a β angle slant in relation to the longitudinal axis (10) of the injector needle (1), the second inner channel (11) extending to the outlet orifice (8); wherein the second end (4) comprises a face (12) slanted at an α angle in relation to the longitudinal axis (10) of the injector needle (1); wherein the outlet orifice (8) is disposed on the slanted face (12).

### FIELD OF THE UTILITY MODEL

The present utility model refers to a constructive arrangement applied to an injector needle. More precisely, the present utility model refers to a constructive arrangement applied to an injector needle used in machines for preparing drinks from capsules.

### BACKGROUND OF THE UTILITY MODEL

Injector needles, or simply needles, are widely used in machines for preparing drinks from capsules.

The main function of the injector needles is to perforate the capsule and inject heated fluid at high pressure inside, in order to prepare a drink by means of extraction or dissolution of ingredients, such as coffee powder, granulated coffee, cocoa powder, powdered milk, leaves, fruits, among others. Commonly, said fluid is pressurized hot water.

Generally speaking, an extractor needle is responsible for extracting the drink prepared from inside the capsule, which is subsequently directed towards a suitable recipient, such as a cup or a beaker.

As known by persons skilled in the art, injector needles are commonly encased or fixed to a needle support, which in turn is encased or fixed in the machine for preparing drinks. The needle support is then connected by means of tubes and valves, or equivalent elements, to the heating unit, which is responsible for supplying hot pressurized water to the injector needle and, consequently, inside the capsule.

Injector needles known in the state of the art are designed to prepare coffee, the drink accounting for the lion's share of the market of drinks prepared from capsules.

An example of injector needle known in the state of the art may be noted in document CN206507792. Said needle presents a central outlet that injects a flow of water into the capsule, perpendicular to the capsule base.

Although this type of flow is satisfactory for preparing just coffee or drinks whose primary ingredient is coffee, it is noted that this arrangement is often not satisfactory for preparing other drinks.

Disadvantageously, it is seen that the preparation of drinks containing powdered milk or similar ingredients has drawbacks still not overcome by the state of the art.

More specifically, the ingredients for preparing milk-based drinks usually form solid blocks inside the capsule, which do no dissolve, even in contact with hot water at high pressure. As a result, not only is the flavor of these drinks impaired, but there is also the waste of undissolved or badly extracted ingredients.

Therefore, the state of the art has no suitable injector needle for providing a flow of pressurized hot water to capsules for preparing drinks comprising milk-based ingredients or the like, such as coffee with milk, cappuccino, and chocolate-mix beverages, among others.

Generally, the state of the art lacks technical solutions for suitably dissolving and/or extracting milk-based ingredients or the like contained in capsules for preparing drinks.

### DESCRIPTION OF THE UTILITY MODEL

It is an objective of the present utility model to provide a suitable injector needle for supplying a flow of pressurized hot water to capsules for preparing drinks comprising milk-based ingredients or the like, such as coffee with milk, cappuccino, and chocolate-mix products, among others.

Another objective of the present utility model is to provide a suitable injector needle for dissolving and extracting milk-based ingredients or the like in capsules for preparing drinks, enhancing the flavor of the ready-to-drink beverages and preventing wastage of undissolved or badly extracted ingredients.

One or more objectives of the present utility model mentioned above, among others, are achieved by way of an injector needle comprising the first end endowed with a fastening means; the second end endowed with a tip; a central portion interconnecting the first and second ends; wherein the first end comprises an inlet orifice and the second end comprises an outlet orifice; the injector needle further comprising a first inner channel extending in parallel to a longitudinal axis of the injector needle, the first inner channel extending from the inlet orifice and fluidly connecting to a second inner channel; the second inner channel having a β angle slant in relation to the longitudinal axis of the injector needle, the second inner channel extending to the outlet orifice; wherein the second end comprises a face having an α angle slant in relation to the longitudinal axis of the injector needle; wherein the outlet orifice is disposed on the slanted face.

### BRIEF DESCRIPTION OF THE DRAWINGS

The objectives, technical effects and advantages of the present utility model will be apparent to persons skilled in the art from the detailed description ahead which refers to the accompanying drawings that illustrate the utility model:

FIG. 1 is a perspective view of the injector needle that is the object of the present utility model;

FIG. 2 is a top view of the injector needle that is the object of the utility model;

FIG. 3 is a bottom view of the injector needle that is the object of the utility model;

FIG. 4 is a front view of the injector needle that is the object of the utility model;

FIG. 5 is a front view of the A-A cut of the injector needle illustrated in FIG. 4; and

FIG. 6 is a right-side view of the injector needle that is the object of the utility model.

### DESCRIPTION OF EMBODIMENTS OF THE UTILITY MODEL

At the outset, it has to be emphasized that the injector needle 1, that is the object of the present utility model, will be described below according to the embodiments represented in the accompanying drawings, said embodiments not being limitative because they can be carried out in different forms and with variations, according to the application desired by the person skilled in the art.

The use of the term “a” or “one” in this specification does not indicate a limited quantity, but rather the existence of at least (minimally) one of the elements/components/items listed. The use of the term “or” indicates any of or all the elements/components/items listed. The use of the term “comprise”, “endowed”, “provided” or any similar term indicates that the element/component/item listed before said term is part of the invention, but do not exclude other elements/components/items not listed. The use of the term “associate”, “connect” or similar terms may refer to physical, mechanical, pneumatic, fluid, hydraulic, electric, electronic or wireless connections, be it directly or indirectly.

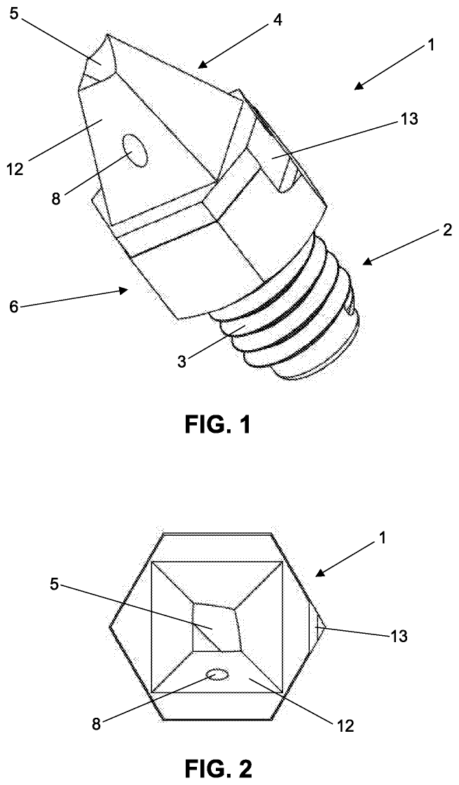

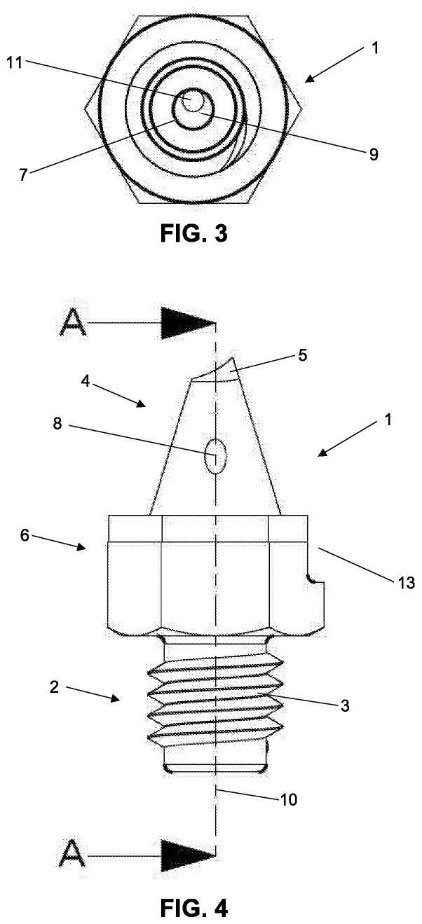

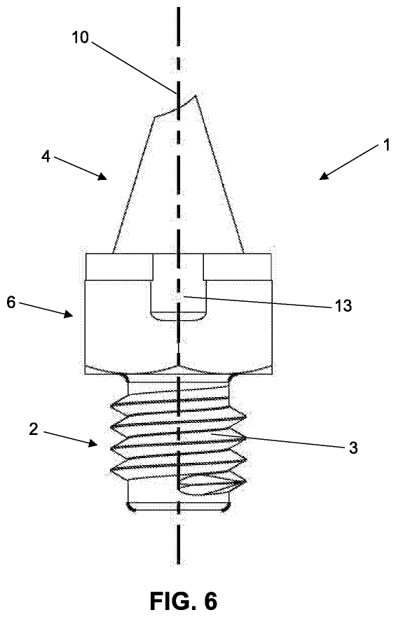

As can be seen in FIGS. 1 to 6, the injector needle 1 comprises a first end 2 endowed with a fastening means 3, a second end 4 endowed with a tip 5 and a central portion 6 interconnecting the first 2 and second 4 ends.

The function of the fastening means 3 is to establish a mechanical and fluid connection between the injector needle 1 and the machine for preparing drinks from capsules (not illustrated).

More specifically, the fastening means 3 establishes a mechanical and fluid connection between the injector needle 1 and a needle support (not illustrated), which can be connected to a heating unit of the machine (not illustrated). As stated previously, the heating unit is responsible for supplying pressurized hot water to the injector needle 1 and, consequently, inside the capsule.

In an embodiment of the present utility model, the first end 2 is endowed with a substantially cylindrical shape, and the fastening means 3 are M5 threads formed on the surface of the first end 2.

Obviously, the use of threads as fastening means 3 of the injector needle 1 does not represent a limitation or obligation of the present utility model, such that a person skilled in the art may select the fastening means he/she understands most recommendable in accordance with the design and with the teachings of the present utility model.

The function of the tip 5 of the injector needle 1 is to perforate a seal of the capsule for preparing drinks, enabling the injector needle 1 to apply pressurized hot water inside the capsule. Generally, the seal of the capsule comprises a plastic or metal film.

In the embodiment illustrated by FIGS. 1 to 6, the tip 5 is pointed. However, a person skilled in the art will immediately perceive that the tip 5 can be serrated or even blunt, provided that it satisfactorily meets the function of perforating the seal of the capsule and of injecting pressurized hot water into the capsule.

In an embodiment of the present utility model, the central portion 6 consists of a hexagonal central portion.

Obviously, the hexagonal geometry of the central portion does not represent a limitation or obligation for the utility model. Accordingly, a person skilled in the art may choose other geometries for the central portion according to the needs of each project, such as, for example, a cylinder or square.

The function of the central portion 6 is to make the interconnection between the first 2 and second 4 ends. Optionally, the central portion 6 is endowed with a recess 13.

The injector needle 1 can be modular or can be made of a single part, according to the specifications of each project. A non-limitative example of modular injector needle 1 comprises the first end 2, the central portion 6 and the second end 4 made as independent parts connected to each other to form the injector needle 1.

In an embodiment of the present utility model, a free portion/base of the first end 2 comprises an inlet orifice 7 and the second end 4 comprises an outlet orifice 8.

The second end 4 comprises a face 12 slanted at an α angle in relation to the longitudinal axis 10 of the injector needle 1. In other words, the slanted face 12 does not extend in parallel to the longitudinal axis 10 of the injector needle 1.

In an embodiment of the present utility model illustrated by FIGS. 1 to 6, the second end 4 is in the shape of a square-based pyramid trunk. A person skilled in the art will immediately envisage other possible formats for the second end 4, such as, for example, a triangular-base pyramid trunk.

In an embodiment of the present utility model, the outlet orifice 8 is disposed on the slanted face 12.

According to the teachings of the present utility model, the injector needle 1 further comprises a first inner channel 9 extending in parallel to a longitudinal axis 10 of the injector needle 1. The first inner channel 9 extends from the inlet orifice 7 and fluidly connects to a second inner channel 11.

The second inner channel 11 is slanted at a β angle in relation to the longitudinal axis 10 of the injector needle 1 and extends to the outlet orifice 8.

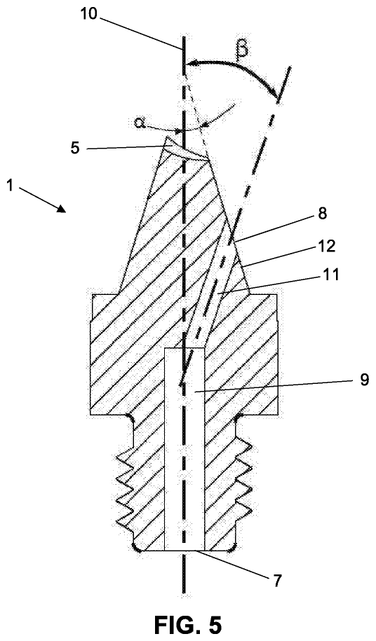

As can be noted in FIG. 5, a fluid connection between the inlet orifice 7, the first inner channel 9, the second inner channel 11 and the outlet orifice 8 define a path for a flow of pressurized hot water, which can be subsequently injected into the capsule for preparing drinks.

In an embodiment of the present utility model, the 13 angle between the second inner channel 11 and the longitudinal axis 10 is comprised in the range between 5° and 90°.

The slant of the second inner channel 11 in relation to the longitudinal axis 10 provides for the creation of a turbulent flow of water into the capsule when it is injected by means of the injector needle 1. Said turbulent flow provides improved dissolution and/or extraction of the ingredients contained inside the capsule. Accordingly, any solid blocks formed by milk-based ingredients or the like can be efficiently dissolved and/or extracted and destined for ready-to-drink beverage.

In another embodiment of the present utility model, the α angle between the face 12 and the longitudinal axis 10 is comprised in the range between 5° and 90°.

The slant of the slanted face 12 facilitates the withdrawal of the injector needle 1 from the capsule after perforating the seal and preparing the drink, besides minimizing the risk that any seal fragments from the capsule stick to the injector needle 1 or block the outlet orifice 8.

In an embodiment of the present utility model, the diameter of the first inner channel 9 is equal to the diameter of the second inner channel 11.

Optionally, the diameter of the first inner channel 9 is greater than the diameter of the second inner channel 11. In particular, the diameter of the first inner channel 9 is comprised in the range between 0.4 and 2.5 mm, more preferably between 1.3 and 1.8, whereas the diameter of the second inner channel 11 is comprised in the range between 0.4 and 2.5 mm, more preferably 0.6 and 1.2 mm.

The difference between the diameters of the first 9 and second 11 inner channels enables an increase in the water pressure between the first 9 and the second 11 inner channels. This increase in water pressure helps maintain the turbulent flow inside the capsule as the drink is prepared, enabling improved extraction/dissolution of the ingredients.

In an embodiment of the present utility model, the injector needle has a height, that is, the distance between the base of the first end 2 and the tip 5, of 15.5 mm. In this embodiment, the first end 2 has a height of 5.1 mm, the central portion 6 has a height of 4.5 mm and the second end 4 has a height of 5.9 mm.

Obviously, said dimensions do not represent limitations or obligations for the utility model, such that a person skilled in the art may size the injector needle 1 according to the needs of each project.

Preferably, the injector needle 1 is made of ceramic materials. However, other materials can be used, such as plastics or metal alloys, provided they support the working conditions of the machine for preparing drinks and do not interfere with the organoleptic properties of the ready-to-drink beverages.

Preferably, the injector needle 1 is manufactured from injection processes. However, said manufacturing process does not represent a limitation or obligation of the present utility model, such that a person skilled in the art may select the manufacturing process he/she understands most recommendable in accordance with the design and with the teachings of the present utility model.

If the injector needle 1 is manufactured from injection, the presence of the recess 13 in the central portion 6 is particularly advantageous. In this context, the recess 13 can serve as an injection point of the material in the injection mold and prevent any burrs or traces stemming from the injection process from interfering with the use or maintenance of the injector needle 1.

For example, if a user wishes to fix to or remove the injector needle 1 from the needle support with the assistance of a ratchet, the recess 13 enables the encasement of the injector needle 1 in the ratchet not to be adversely affected by burrs or traces.

Although the injector needle 1 is suitable for use in machines for preparing drinks comprising milk-based ingredients, a person skilled in the art will perceive that the utility model can be applied to preparing drinks without milk-based ingredients, such as espresso coffee or tea.

Furthermore, a person skilled in the art will perceive that the utility model can be applied to machines not necessarily designed for preparing drinks. As an example, the present utility model can be applied to machines for preparing foodstuffs, such as soup or broth.

An advantage of the present utility model consists of improved extraction of the ingredients contained inside the capsule, consequently enhancing the flavor of the ready-to-drink beverage and providing greater appeal to consumers.

Another advantage consists of less wastage of the ingredients in the capsule, in view of the improved extraction and/or dissolution provided by the present injector needle 1.

Notwithstanding the description of the particular embodiments above, the present utility model can be carried out in similar ways, and the form of implementation may differ, such that the scope of protection of the utility model is solely limited by the content of the accompanying claims, including all the possible equivalent variations connected to the model represented in the drawings.

1. An injector needle (1) comprising:
a first end (2) endowed with a fastening means (3);
a second end (4) endowed with a tip (5);
a central portion (6) interconnecting the first and second ends (2, 4);
wherein the first end (2) comprises an inlet orifice (7) and the second end (4) comprises an outlet orifice (8);
the injector needle (1) further comprising a first inner channel (9) extending in parallel to a longitudinal axis (10) of the injector needle (1), the first inner channel (9) extending from the inlet orifice (7) and fluidly connecting to a second inner channel (11);
the second inner channel (11) having a β angle slant in relation to the longitudinal axis (10) of the injector needle (1), the second inner channel (11) extending to the outlet orifice (8);
wherein the second end (4) comprises a face (12) slanted at an α angle in relation to the longitudinal axis (10) of the injector needle (1);
wherein the outlet orifice (8) is disposed on the slanted face (12).

2. The needle (1) according to claim 1, wherein the α angle is between 5° and 90°.

3. The needle (1) according to claim 1, wherein the β angle is between 5° and 90°.

4. The needle (1) according to claim 1, wherein the diameter of the first inner channel (9) is between 0.4 and 2.5 mm.

5. The needle (1) according to claim 1, that wherein the diameter of the second inner channel (11) is between 0.4 and 2.5 mm.

6. The needle (1) according to claim 1, wherein the fastening means (3) comprises threads formed on the surface of the first end (2); the tip (5) is a pointed tip and the central portion (6) is endowed with a recess (13).

7. The needle (1) according to claim 1, wherein a diameter of the first inner channel (9) is equal to a diameter of the second inner channel (11).

8. The needle (1) according to claim 1, wherein a diameter of the first inner channel (9) is greater than a diameter of the second inner channel (11).

9. The needle (1) according to claim 8, wherein the diameter of the first inner channel (9) is between 0.4 and 2.5 mm and the diameter of the second inner channel (11) is between 0.4 and 2.5 mm.

10. The needle (1) according to claim 1 that is modular.

11. The needle (1) according to claim 1 that is a single part.

12. The needle (1) according to claim 1 made of ceramic material.

13. The needle (1) according to claim 1 made of plastic or metal alloy.

14. The needle (1) according to claim 1, wherein the second end (4) is in the shape of a square-based pyramid trunk.

15. The needle (1) according to claim 1, wherein the second end (4) is in the shape of a triangle-based pyramid trunk.
